(19) United States
(12) Patent Application Publication
(10) Pub. No.: US 2021/0055749 A1
(43) Pub. Date: Feb. 25, 2021

(54) A VALVE DEVICE

(71) Applicant: Reliance Worldwide Corporation (Aust.) Pty. Ltd., Eagle Farm (AU)

(72) Inventors: Gary HAY, Eagle Farm (AU); David FORRESTAL, Eagle Farm (AU); Greg HARRAP, Eagle Farm (AU)

(73) Assignee: Reliance Worldwide Corporation (Aust.) Pty. Ltd., Eagle Farm (AU)

(21) Appl. No.: 16/979,053

(22) PCT Filed: Mar. 8, 2019
(86) PCT No.: PCT/AU2019/050209

§ 371 Date: Sep. 8, 2020

(30) Foreign Application Priority Data
Mar. 9, 2018 (AU) 2018900783

(51) Int. Cl. G05D 23/13

(52) U.S. Cl. CPC G05D 23/134

(57) ABSTRACT

A valve device including a first wall configured to be received by a valve housing; a second wall located in an inboard direction of the first wall; and a connecting member connecting the first wall to the second wall, wherein at least the second wall has an aperture therethrough in the inboard direction.

### RELATED APPLICATIONS

The present application claims priority to Australia Provisional Patent Application No 2018900783 filed on 9 Mar. 2018, the disclosure of which is herein incorporated by reference in its entirety for all purposes.

### FIELD OF THE INVENTION

The invention relates to a valve device. In particular, the invention relates, but is not limited, to a valve device in the form of a piston for a thermostatic mixing valve. The invention also relates to a valve incorporating the valve device and a method for operating the valve.

### BACKGROUND TO THE INVENTION

Reference to background art herein is not to be construed as an admission that such art constitutes common general knowledge in Australia or elsewhere.

A thermostatic mixing valve (TMV) is a valve associated with blending hot water with cold water to achieve a substantially constant temperature.

Many TMVs use a wax thermostat element, coupled to a piston, for regulating temperature. Normally, an upper and lower face of the piston is positioned to allow separate gaps to be formed between respective sealing surfaces in the TMV. In response to the thermostatic element being exposed to cold water, the thermostatic element shrinks and moves towards one of the sealing surfaces. This restricts the flow of cold water entering the TMV. Similarly, in response to the thermostatic element being exposed to hot water, the thermostatic element expands and moves towards another sealing surface. This restricts the flow of hot water entering the TMV.

As a result of the abovementioned movement of the thermostatic element and piston, the TMV is able to maintain a substantially constant outlet temperature (within a few degrees). In order to set the constant outlet temperature a spindle is adjusted. The spindle sets a position of the element and piston at a specific height under stable inlet conditions. In response to the spindle moving in a first direction (i.e. towards the hot inlet gap), the stable temperature will be relatively colder, and conversely if the spindle is moved in an opposite direction, the stable temperature will be hotter.

In designing TMVs there are, amongst other things, two key performance aspects in the form of i) the pressure drop across the valve; and ii) the thermostatic performance of the valve (i.e. how accurate the valve maintains a constant temperature outlet). Reducing the pressure drop across the TMV allows, for example, higher pressure showers and, in a system where a pump is used, a less expensive pump may achieve a predetermined flow rate. Maintaining an outlet temperature within ±0.5° C. is also preferable to avoid other associated performance and safety issues.

It will be appreciated that for a given design, there is a trade-off between the pressure drop across the valve and the thermostatic performance. Typically, it is possible to improve the thermostatic performance, but this results in a more restrictive valve, and vice versa.

With the above in mind, as a given thermostatic element will move a set distance for a specific change in temperature, and that movement is responsible for opening or closing the inlet gaps, then it can be appreciated that the size of these inlet gaps (in an axial direction) is a factor that determines the thermostatic performance. Large inlet gaps will have poorer thermostatic performance than small gaps as a larger amount of travel of the thermostatic element is required to change the temperature.

Improved thermostatic performance can therefore be achieved by having smaller inlet gaps above and below the piston. That being said, reducing the size of these inlets will also cause the valve to be more restrictive to fluid flow. In this way, the relationship between the pressure drop across the valve and thermostatic performance can be understood.

In an attempt to improve thermostatic performance, thermostatic elements have been developed to allow further movement for a given change in temperature. However, there are a number of issues associated with this potential design choice. First, unless there are excessive costs in choosing a higher performing thermostatic element, designers typically choose the best performing element that matches the TMV in the first instance. Secondly, an element that has more travel will typically require more material to drive its movement. This additional material will require more heat input for a given change in temperature, so while the element will move further, it will also react slower. The speed of adjustment is often a crucial requirement for thermostatic performance testing.

Separately, in attempts to reduce the pressure drop across a TMV, larger diameter pistons have been considered. This allows the inlet gap areas to be increased without changing the distance required for the thermostat element to shut off or open up the inlets. This means that the valve will be less restrictive to flow without affecting the thermostatic performance. Although, as the piston diameter is increased so too is the diameter of the valve body and other associated components. This results in increased cost for the TMV.

The present inventors have developed an improved device for a thermostatic mixing valve.

### SUMMARY OF INVENTION

In one form, the invention resides in a valve device including:

a first wall configured to be received by a housing;

a second wall located in an inboard direction of the first wall; and

a connecting member connecting the first wall to the second wall,

wherein at least the second wall has an aperture therethrough in the inboard direction.

The valve device provides, amongst other things, an increase in inlet area via the aperture without affecting the distance required for a thermostatic element to adjust the flow through inlets of a valve. This is achieved without the valve device or valve housing increasing in size and results in a valve design with improved thermostatic performance and less flow restriction, without significant cost penalties.

In an embodiment, a central axis extends substantially parallel to the first wall and/or the second wall and transversely to the inboard direction.

In an embodiment, the central axis extends between the ends of the first wall and the second wall. The ends are normally the upper end and lower end of the valve device.

In an embodiment, end faces of the first wall and/or second wall extend in the inboard direction.

In an embodiment, at least part of a first passage is located between the first wall and the second wall.

In an embodiment, the first passage extends substantially transverse to the inboard direction.

In an embodiment, the first passage may also extend transversely to the aperture.

In an embodiment, the first passage extends along the first wall and the second wall around the connecting member.

In an embodiment, the passage has one or more openings, adjacent the ends of the walls, extending transversely to the inboard direction.

In an embodiment, the first wall and/or the second wall are annular.

In an embodiment, the central axis defines the centre point for the circular arc of the first wall and/or the second wall.

In an embodiment, the aperture may extend through the first wall. In a further form, separate holes may form part of the aperture.

In an embodiment, the second wall includes a plurality of apertures extending therethrough in the inboard direction.

In an embodiment, the connecting member extends substantially in the inboard direction.

In an embodiment, the connecting members include the aperture therethrough.

In an embodiment, the valve device includes an interior member. In an embodiment, the interior member is configured to receive a force from a thermostatic element and/or spring.

In an embodiment, the interior member is substantially circular.

In an embodiment, the interior member is connected to the second wall with one or more connecting parts.

In an embodiment, a second passage extends along the second wall and the interior member.

In an embodiment, the interior member includes a base portion that is configured to engage with the thermostatic element.

In an embodiment, the valve device is in the form of a piston.

In an embodiment, the valve device includes a flow separator.

In an embodiment, the flow separator is located between the second wall and the interior member.

In an embodiment, the flow separator separates the second passage into a first portion and a second portion.

In another form, the invention resides in a valve including:

a housing having a first fluid inlet, a second fluid inlet and an outlet;

a valve device biased by a spring, the valve device including:
a first wall;
a second wall located in an inboard direction of the first wall; and
a connecting member connecting the first wall to the second wall;

and

a thermostatic element configured to provide a force to the valve device in order to provide movement thereof,

wherein at least the second wall has an aperture therethrough in the inboard direction and movement of the valve device controls fluid flow from the first fluid inlet or the second fluid inlet, through the aperture, to the outlet.

In an embodiment, the aperture extends in a transverse direction to an axis of the valve. In an embodiment, the axis of the valve is aligned with the thermostatic element.

In an embodiment, the aperture is configured to be in fluid communication with the first fluid inlet whilst a further aperture extending through the second wall in the inboard direction is configured to be in fluid communication with the second fluid inlet.

In an embodiment, movement of the valve device controls fluid flow from:

the first fluid inlet, through the aperture configured to be in fluid communication with the first fluid inlet, to the outlet; and

the second fluid inlet, through the further aperture configured to be in fluid communication with the second fluid inlet, to the outlet.

In an embodiment, the flow separator substantially prevents fluid moving between the first portion and the second portion.

In an embodiment, the aperture is in fluid communication with the first portion and first fluid inlet; and another aperture is in fluid communication with the second portion and second fluid inlet.

In an embodiment, the valve includes a setting member.

In an embodiment, the setting member is connected to the valve device.

In an embodiment, the setting member is connected to the valve device via one or more pegs.

In an embodiment, the one or more pegs are retained on the top and/or bottom of the device.

In an embodiment, the one or more pegs includes two pegs that are located on opposite sides of the one or more openings.

In an embodiment, the valve includes one or more seat members.

In an embodiment, the one or more seat members are separate components to the housing.

In an embodiment, the one or more seat members include a seating portion that is configured to cover the first passage of the valve device.

In an embodiment, in response to the first wall and second wall of the device engaging with the seating portion, fluid flow through the first inlet or second inlet to the outlet is substantially prevented.

In an embodiment, the one or more seat members includes one or more apertures to provide a fluid path to the valve device.

In an embodiment, the one or more apertures are located inboard from the seating portion of the one or more seat members.

In an embodiment, the one or more apertures may be located closer to the longitudinal axis of the valve in comparison to the first passage of the valve device.

In an embodiment, the one or more seat members include an extending member. The extending member may extend from a location near the one or more apertures.

In an embodiment, the extending member is configured to assist in channelling fluid flow through the one or more apertures to the first passage of the valve device.

In an embodiment, the extending member includes a sealing portion that is configured to assist in sealing against the valve device.

In an embodiment, the valve device is configured to rotatably engage the one or more seat members.

In an embodiment, the valve device rotably engages the one or more seat members via the one or more pegs.

In an embodiment, the valve includes an adjustment member. The adjustment member may be in the form of a spindle.

In an embodiment, the adjustment member is releasably engaged with the one or more seat members.

In an embodiment, the one or more seat members include one or more legs that are configured to engage the adjustment member.

In an embodiment, the adjustment member includes a fastening portion that is configured to be releasably fasten to the housing.

In an embodiment, the adjustment member is configured to engage with a portion of the thermostatic element.

In an embodiment, a portion of the thermostatic element extends through the adjustment member.

In an embodiment, in response to rotating at least part of the setting member, the distance between the thermostatic element and valve device is adjusted via turning the adjustment member.

In an embodiment, the valve includes more than one thermostatic element.

In another form the invention resides in a valve including:

a housing having a first fluid inlet, a second fluid inlet and an outlet;

a setting member;

a device biased by a spring, the device being connected to the setting member;

a seat member that engages with the device and an adjustment member; and

a thermostatic element configured to apply a force on the device in order to provide movement thereof, movement of the device controlling fluid flow from the first fluid inlet and the second fluid inlet to the outlet,

wherein rotating the setting member adjusts the distance between the thermostatic element and device, via the seat member and the adjustment member, in order to set a predetermined temperature.

In an embodiment, the valve is herein as described.

In another form the invention resides in a method of regulating temperature in a valve, the method including the steps of:

providing fluid to a first fluid inlet;

providing fluid to a second fluid inlet;

allowing the fluid from the first fluid inlet to flow past a first wall of a valve device and through a first aperture of a second wall of the valve device, the first aperture extending through the second wall in an inboard direction between the first wall and the second wall;

allowing the fluid from the second fluid inlet to flow past the first wall and through a second aperture of the second wall, the second aperture extending in the inboard direction; and

moving the device in order to adjust the fluid flow from the first fluid inlet and the second fluid inlet, past the valve device, to substantially achieve a predetermined fluid temperature from an outlet.

In an embodiment, the method further includes allowing the fluid from the first inlet and/or second inlet to proceed between the valve device and one or more seat members.

In an embodiment, the fluid moves past one or more apertures of the one or more seat members to a passage defined between the first wall and the second wall.

In an embodiment, the fluid moves past the second wall in order to enter the passage. The fluid may be directed in an outboard direction to move past the one or more apertures to the passage.

In an embodiment, the method further includes the step of rotating a setting member in order adjust the distance between a thermostatic element and the valve device.

Further features and advantages of the present invention will become apparent from the following detailed description.

### BRIEF DESCRIPTION OF THE DRAWINGS

By way of example only, preferred embodiments of the invention will be described more fully hereinafter with reference to the accompanying figures, wherein:

FIG. 1 illustrates a perspective view of a (thermostatic mixing) valve, according to an embodiment of the invention;

FIG. 2 illustrates a cross sectional view of the thermostatic mixing valve illustrated in FIG. 1;

FIG. 3 illustrates an exploded view of the thermostatic mixing valve illustrated in FIG. 1;

FIG. 4 illustrates an upper perspective view of a (valve) device in the form of a piston, shown in the thermostatic mixing valve of FIG. 1, according to an embodiment of the invention;

FIG. 5 illustrates a lower perspective view of the piston shown in FIG. 4;

FIG. 6 illustrates a top view of the piston shown in FIG. 4;

FIG. 7 illustrates a cross sectional view of the piston shown in FIG. 4;

FIG. 8 illustrates a top view of the thermostatic mixing valve illustrated in FIG. 1;

FIG. 9 illustrates a cross sectional view of the thermostatic mixing valve, during use, along line A-A illustrated in FIG. 8;

FIG. 10 illustrates a cross sectional view of the thermostatic mixing valve, during use, along line B-B illustrated in FIG. 8;

FIG. 11 illustrates a cross sectional view of the thermostatic mixing valve, during use, along line C-C illustrated in FIG. 8;

FIG. 12 illustrates a cross sectional view of a (thermostatic mixing) valve, according to a further embodiment of the invention;

FIG. 13 illustrates a cross sectional view of a (thermostatic mixing) valve, according to another embodiment of the invention;

FIG. 14 illustrates a top view of a (valve) device in the form of a piston, shown in the thermostatic mixing valve of FIG. 13, according to a further embodiment of the invention;

FIG. 15 illustrates a perspective view of the piston shown in FIG. 14;

FIG. 16 illustrates a perspective view of a seat member, shown in the thermostatic mixing valve of FIG. 13, according to an embodiment of the invention;

FIG. 17 illustrates a further perspective view of the seat shown in FIG. 16;

FIG. 18 illustrates a perspective view of a further seat member, shown in the thermostatic mixing valve of FIG. 13, according to an embodiment of the invention;

FIG. 19 illustrates a further perspective view of the seat member shown in FIG. 18;

FIG. 20 illustrates a cross sectional view of the thermostatic mixing valve, shown in FIG. 13, during use; and

FIG. 21 illustrates a perspective sectional view of the thermostatic mixing valve, shown in FIG. 13 and FIG. 20, during use.

### DETAILED DESCRIPTION OF THE DRAWINGS

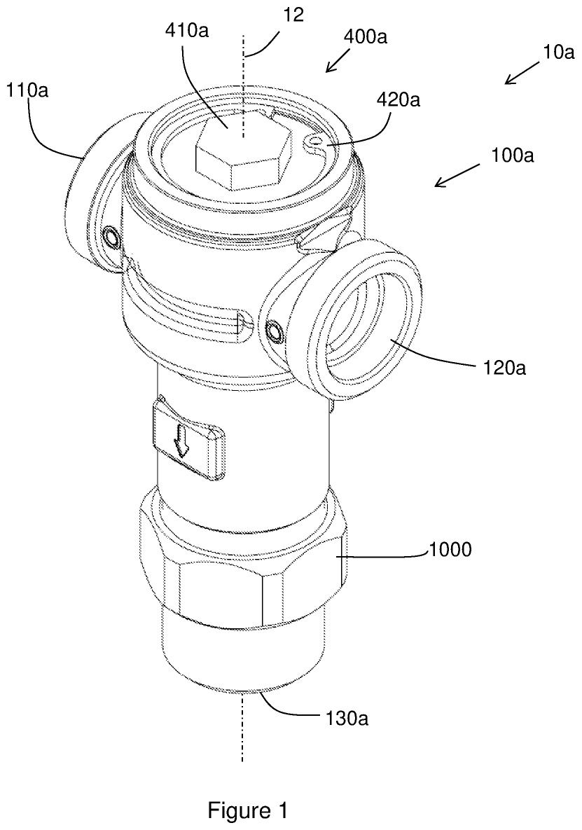

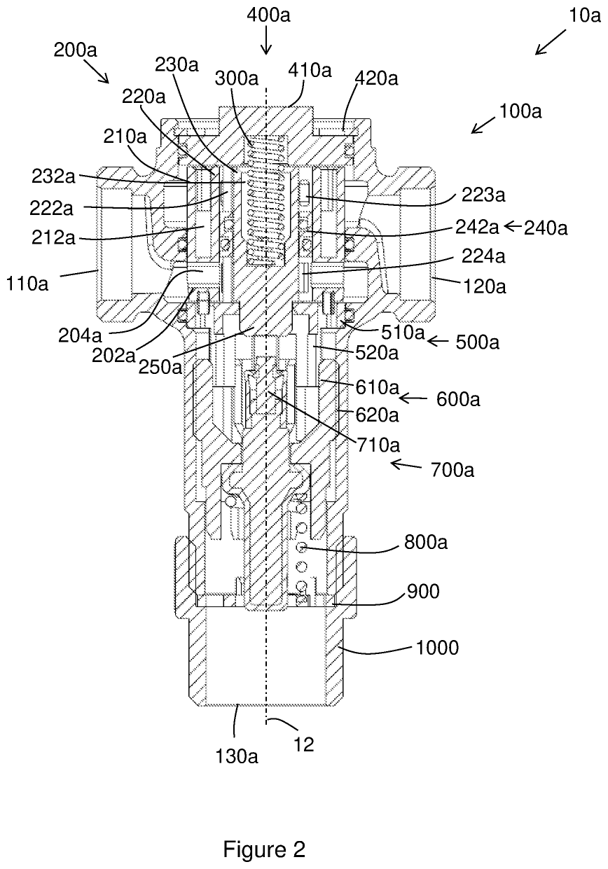

FIGS. 1 and 2 illustrate a thermostatic mixing valve 10a, according to an embodiment of the invention. The valve 10a includes a housing 100a, a valve device in the form of piston 200a, a return spring 300a, a setting member 400a, a seat member 500a, an adjustment member 600a, a thermostatic element 700a, an overtravel spring 800a, a seat 900a and an outlet fitting 1000.

As shown further in FIG. 2, the housing 100a includes a first inlet 110a, a second inlet 120a and an outlet 130a. The first inlet 110a and second inlet 120a are symmetrically located about an axial axis 12. The axis 12 extends longitudinally along the valve 10a. The first inlet 110a and the second inlet 120a taper towards the piston 200a. The first inlet 110a is typically connected to a relative cold fluid source whilst the second inlet 120a is normally connected to a relative hot fluid source. As outlined below, the housing 100a is configured to receive the components above (i.e. the piston 200a, return spring 300a etc.) therein.

The piston 200a, which is cylindrical in this embodiment, is illustrated in detail in FIGS. 2 to 7. As shown in FIG. 2, the piston 200a is located adjacent the first inlet 110a and the second inlet 120a. The first inlet 110a leads into a lower passage that extends around the valve 10a between the housing 100a and piston 200a. Similarly, the second inlet 120a leads into an upper passage that extends around the valve 10a between the housing 100a and piston 200a. The upper and lower passages are fluidly sealed from each other.

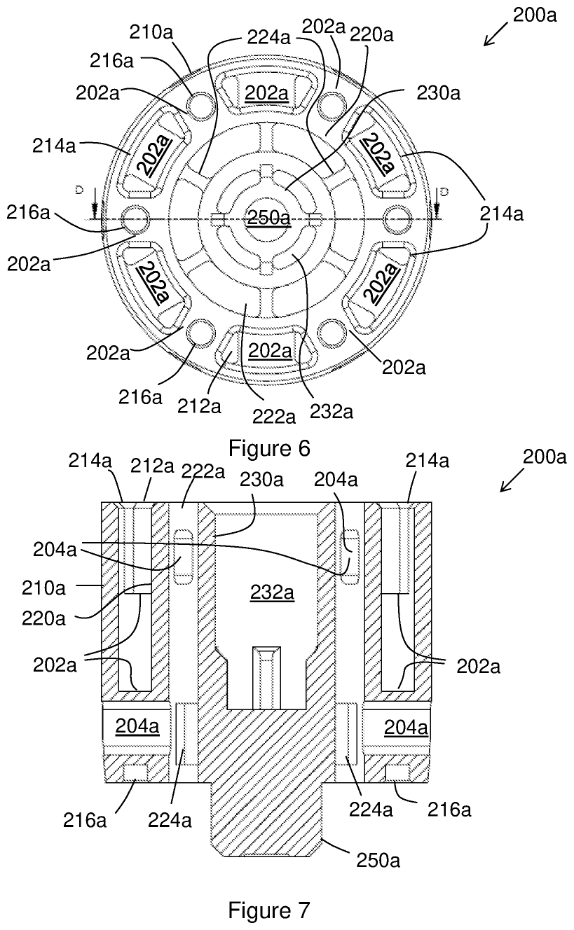

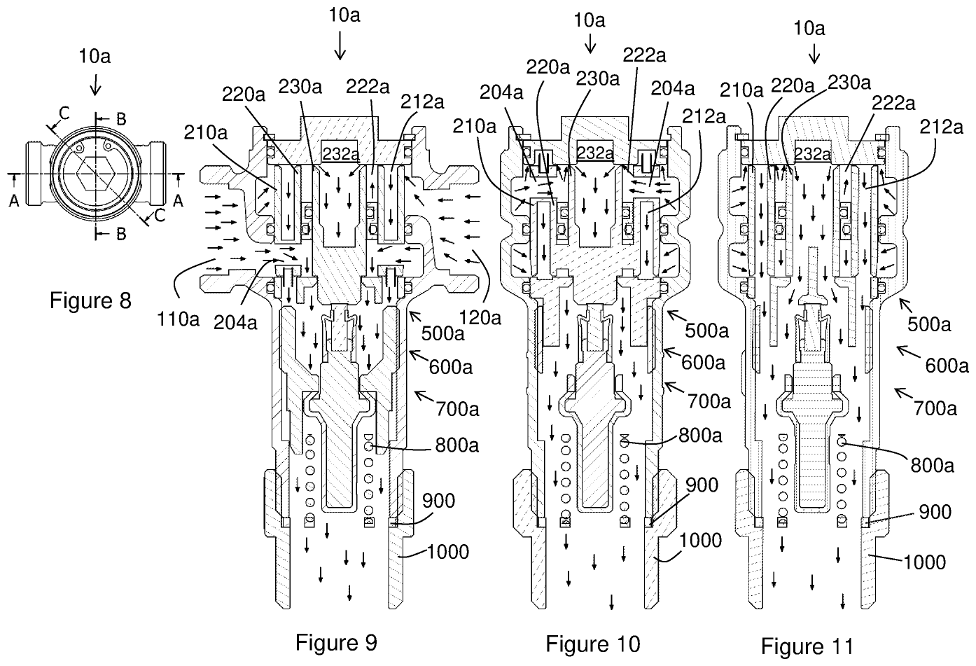

The piston 200a includes a first wall 210a, a second wall 220a and an interior member 230a. The walls 210a, 220a have a top face, bottom face and an inner and outer circular side face. The second wall 220a is located inboard of the first wall 210a and, as such, the first wall 210a is an outer wall relative to the (inner) second wall 220a. In this regard, an inboard direction of the piston 200a is established from the first wall 210a towards the inner second wall 220a. That is, the inboard direction moves towards the axis 12. Connecting members 202a connect the first wall 210a to the second wall 220a. The connecting members 202a are located at an upper portion and lower portion of the piston 200a. As shown further in FIG. 6, the upper connecting members 202a are offset with respect to the lower connecting members 202a. The connecting members 202a are substantially evenly spaced around the piston 200a such that they are symmetrical about the axial axis 12.

The connecting members 202a each include an aperture 204a therethrough. The apertures 204a extend through the first wall 210a and second wall 220a such that outside the first wall 210a is in fluid communication with inboard of the second wall 220a. The apertures 204a extend in the inboard direction and substantially perpendicular to the axial axis 12. In further embodiments, it will be appreciated that the apertures 204a may take a variety of shapes and, for example, include one or more additional inlets/outlet holes. It will also be appreciated that the apertures 204a may be considered to extend in the outboard direction whilst also extending in the inboard direction but, for clarity and context, are preferably recited as extending in the inboard direction.

A first passage 212a separates and is formed between the first wall 210a and second wall 220a. Accordingly, as would be appreciated by a person skilled in the art, the first passage 212a is substantially cylindrical in this embodiment and extends around the connecting members 202a. The first passage 212a extends along the first wall 210a and second wall 220a in a direction that is substantially parallel with the axial axis 12.

The first passage 212a includes a plurality of openings 214a in the top and the bottom of the piston 200a. The openings 214a in the top of the piston 200a are offset with respect to the openings 214a in the bottom of the piston 200a. The plurality of openings 214a are substantially in the form of slots and located at equal distance around the piston 200a. Adjacent the openings 214a are holes 216a. The holes 216a extend partly through the connecting members 202a but not into the apertures 204a.

A second passage 222a separates the second wall 220a and the interior member 230a. Connecting ribs 224a connect the second wall 220a to the interior member 230a. On this basis, similar to the above, it would be appreciated that the second passage 222a is substantially cylindrical in this embodiment and extends around the connecting ribs 224a. The second passage 222a extends along the second wall 220a and the interior member 230a in a direction that is substantially parallel with the axial axis 12.

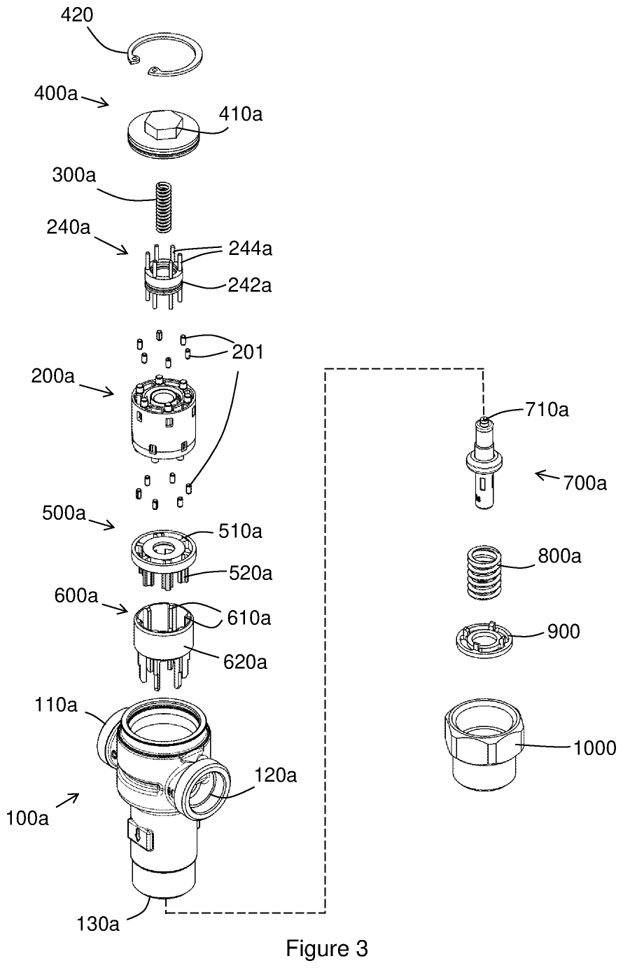

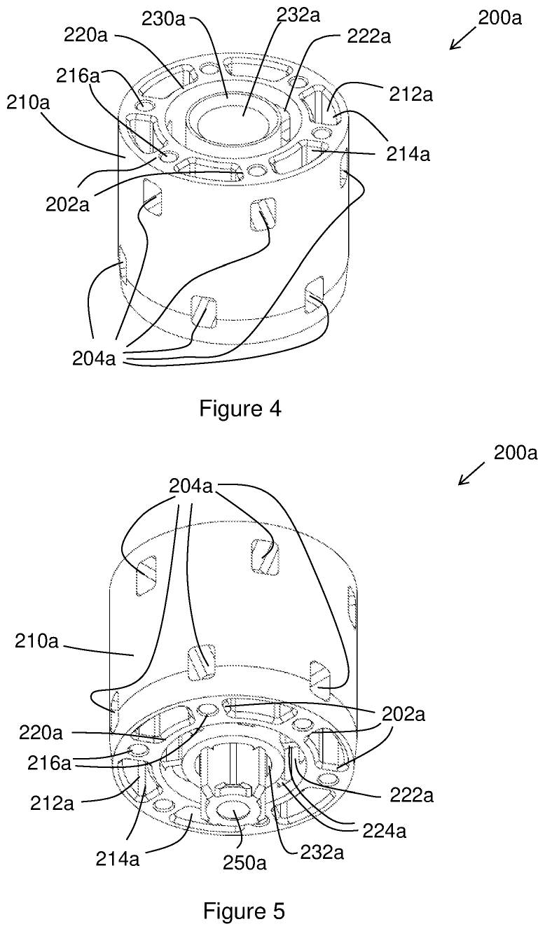

A flow separator 240a separates the second passage 222a into a first (lower) portion and a second (upper) portion. As shown in FIGS. 2 and 3, the flow separator 240a includes a separating portion 242a that is substantially ‘S’ shape. The ‘S’ shape defines two hollows that are configured to receive a seal therein. The flow separator 240a also includes a plurality of protrusions 244a extending from the separating portion 242a. The protrusions 244a assist in locating the flow separator 240a in the second passage 222a. For ease of reference, the flow separator is not shown in FIGS. 4 to 7 associated with the piston 200a.

The interior member 230a includes a third passage 232a therethrough. The interior member 230a is substantially hollow due to the third passage 232a. The interior member 230a includes a base portion that is configured to receive the return spring 300a thereon. An extension portion 250a extends from the base portion. The extension portion 250a extends below the first wall 210a and the second wall 220a.

The return spring 300a, which is in the form of a coil spring in this embodiment, extends between the piston 200a and the setting member 400a. This in turn biases the piston 200a along the axial axis 12 away from the setting member 400a. The setting member 400a includes a recess to receive the return spring 300a therein. With this in mind, the setting member 400a is also connected to the piston 200a via pegs 201. The pegs 201 extend between the holes 216a in the piston 200a and holes in the setting member 400a. Sufficient space exists between the holes 216a in the piston and holes in the setting member 400a to allow the piston 200a to move to a position where it substantially seals against the setting member 400a. This is further outlined below.

The setting member 400a also includes a connector 410a for assisting to rotate the setting member 400a with, amongst other things, a socket wrench. In response to rotating the setting member 400a, the piston 200a is also configured to rotate via the pegs 201. The setting member 400a is retained in the housing 100a via a clip 420a.

Seat member 500a is located adjacent to the piston 200a. That is, the seat member 500a is located below the piston 200a and sits on a shoulder formed in the housing 100a. The seat member 500a includes a seating portion 510a and a plurality of legs 520a extending therefrom. The seating portion 510a is substantially circular and includes a plurality of apertures therethrough. The plurality of apertures are configured to engage with the pegs 201 that are extending below the piston 200a. Furthermore, the seating portion 510a is configured to seal against the piston 200a when there is contact therebetween. The legs 520a extend below the seating portion 510a and are configured to engage with the adjustment member 600a.

The adjustment member 600a includes a plurality of protrusions 610. The protrusions 610a are located along an inner wall of the adjustment member 600a. The protrusions 610a are configured to engage with the legs 520a of the seat member 500a. The adjustment member 600a also includes a fastening portion 620a. The fastening portion 620a is in the form of a thread in this embodiment. The fastening portion 620a is configured to releasably fix to an inner wall of the housing 100a.

The adjustment member 600a is also configured to receive the thermostatic element 700a. The thermostatic element 700a engages with a shoulder formed within the adjustment member 600a. The thermostatic element 700a also includes a pin 710a that, with the assistance of a wax portion, is configured to move and engage with the extension portion 250a of the piston 200a. Movement of the pin 710a, whilst engaged with the extension portion 250a, adjusts the position of the piston 200a, as further outlined below. The thermostatic element 700a is urged towards the shoulder formed within the adjustment member 600a via the overtravel spring 800a. The overtravel spring 800a sits on the seat 900a that is retained on a further shoulder in the housing 100a. The outlet fitting 1000 is connected to the lower end of the housing 100a.

FIGS. 9 to 11 illustrate different cross sectional views of the valve 10a, during use, with the return spring 300a removed for ease of reference. As shown in at least FIG. 9, a relatively cold fluid (e.g. approximately ambient temperature or thereabouts) enters the first fluid inlet 110a of the housing 100a. A relatively hot fluid (e.g. approximately 60 to 90 degrees) also enters the second fluid inlet 120a of the housing 100a. In the position shown in FIGS. 9 to 11, the relatively cold and hot fluid proceed through the piston 200a and are mixed to form a predetermined fluid temperature that exits the outlet 130a. This is outlined further below.

With the position of the piston 200a shown in FIGS. 9 to 11, the relatively cold fluid proceeds through the first fluid inlet 110a and is directed along a number of paths that allow it to exit towards the outlet 130a. Some relatively cold fluid is directed directly through a gap between the first wall 210a of the piston 200a and the seat member 500a. This fluid then mixes with the relatively hot fluid and exits the outlet 130a.

Some further relatively cold fluid is i) directed around the passage between the lower part of the first wall 110a and the housing 100a; and then ii) directed out of the gap between the first wall 210a of the piston 200a and the seat member 500a. Additional relatively cold fluid is also directed through the plurality of apertures 204a, via the passage between the lower part of the first wall 110a and the housing 100a, and then into the lower portion of the second passage 222a. From the lower portion of the second passage 222a, the relatively cold fluid may proceed toward the outlet 130a via i) a gap between the second wall 220a and the seat member 500a; or ii) a gap between the interior member 230a and the seat member 500a.

Similar to the above, the relatively hot fluid proceeds through the second inlet 120a and is directed along a number of paths that allow it to exit towards the outlet 130a. Some relatively hot fluid is directed towards a gap between the first wall 210a and the setting member 400a. This fluid then flows down the first passage 212a to exit the outlet 130a whilst being mixed with the relatively cold fluid.

Some further relatively hot fluid is i) directed around the passage between the upper part of the first wall 110a and the housing 100a; ii) through the gap between the first wall 210a and the setting member 400a; and then iii) down the first passage 212a to exit the outlet 130a. Additional relatively hot fluid is also directed through the plurality of apertures 204a, via the passage between the upper part of the first wall 110a and the housing 100a, and then into an upper portion of the second passage 222a. From the upper portion of the second passage 222a, the relatively hot fluid may proceed to the outlet 130a via i) moving up and into the first passage 212a; or ii) moving up and into the third passage 232a. This fluid then flows down the second or third passage 222a, 232a to exit the outlet 130a whilst being mixed with the relatively cold fluid.

In response to a predetermined outlet temperature not being maintained by the valve 10a, the valve 10a is configured to adjust the flow of the relatively hot fluid and cold fluid leaving the outlet 130a via moving the piston 200a. The piston 200a is moved by the pin 710a engaging/disengaging the extension portion 250. By way of example, in response to the outlet temperature being above the predetermined outlet temperature, the wax portion in the thermostatic element grows shifting the pin 710a upwards. This in turn shifts the piston 200a upwards and restricts the amount of relatively hot fluid entering the valve 10a until the predetermined outlet temperature is again substantially reached.

To set the predetermined outlet temperature, the adjustment member 600a is adjusted to a location. To adjust the adjustment member 600a, the setting member 400a is rotated. This in turn rotates the piston 200a, via the pegs 201, which in turn rotates the seat member 500a, via the pegs 201. As the seat member 500a rotates, the adjustment member 600a is caused to rotate through its engagement with the legs 520a. As the adjustment member 600a is rotated, it moves a direction along the axial axis 12 due to the fastening portion 620a.

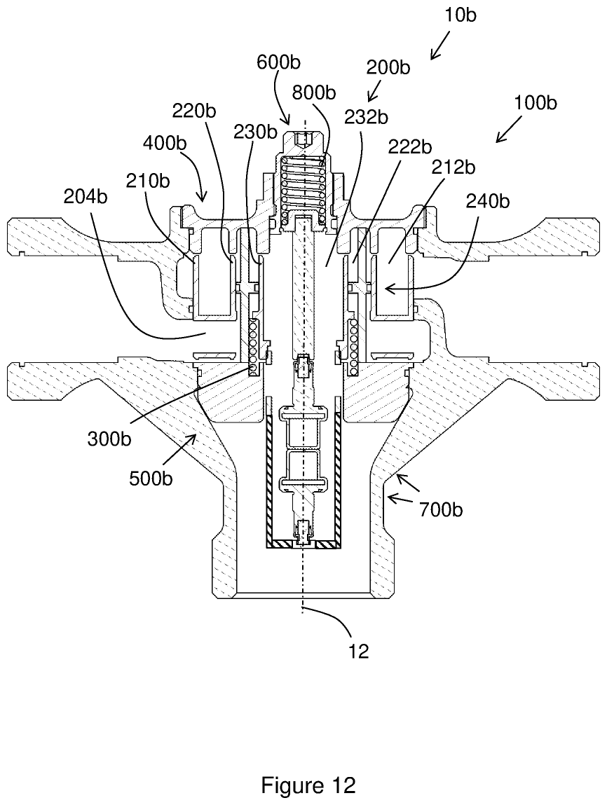

FIG. 12 illustrates a cross sectional view of a thermostatic mixing valve 10b, according to a further embodiment of the invention. With this in mind, in this disclosure the use of a reference numeral followed by a lower case letter indicates alternative embodiments of a general element identified by the reference numeral. Thus for example the thermostatic mixing valve 10a is similar to but not identical to the thermostatic mixing valve 10b. Further, references to an element identified only by the numeral refer to all embodiments of that element. Thus for example a reference to the thermostatic mixing valve 10 is intended to include both the valve 10a and the valve 10b.

Similar to the valve 10a, the valve 10b includes a housing 100b, a valve device in the form of piston 200b, a return spring 300b, a cap 401b, a seat member 500b, an adjustment member 600b, two thermostatic elements 700b and an overtravel spring 800b.

Notably, as a person skilled in the art would appreciate, the thermostatic elements 700b are co-axially located along the axial axis 12 in the valve 10b. This doubles the element 700b travel, when subjected to changes in temperature, which in turn may be used to assist in fulfilling high flow requirements as the piston 200b to seat gap may be larger.

In addition, the adjustment member 600b in the valve 10b has been rearranged, in comparison to the valve 10a, and is located above the piston 200b and adjacent to the setting member 400b. The piston 200b has also been arranged to receive the return spring 300b between the interior member 230b and the flow separator 240b.

The piston 200b, similar to the piston 200a, includes a plurality of apertures 204b extending between the first wall 210b and the second wall 220b. The piston 200b also includes a first passage 212b, a second passage 222b and a third passage 232b, similar to the piston 200a. With this in mind, the valve 10b works substantially in the same manner as valve 10a in controlling the flow of fluid through the apertures 204b, from their respective inlet, to the outlet of the housing 100b. In particular, as the piston 200b moves between the seat member 500b and setting member 400b, the flow of water through the multiple paths in the piston 200b is regulated to achieve a substantially constant predetermined outlet temperature.

In comparison to the valve 10a, the predetermined outlet temperature in the valve 10a is set by directly rotating the adjustment member 600b. This sets a distance between the two thermostatic elements 700b and the piston 200a.

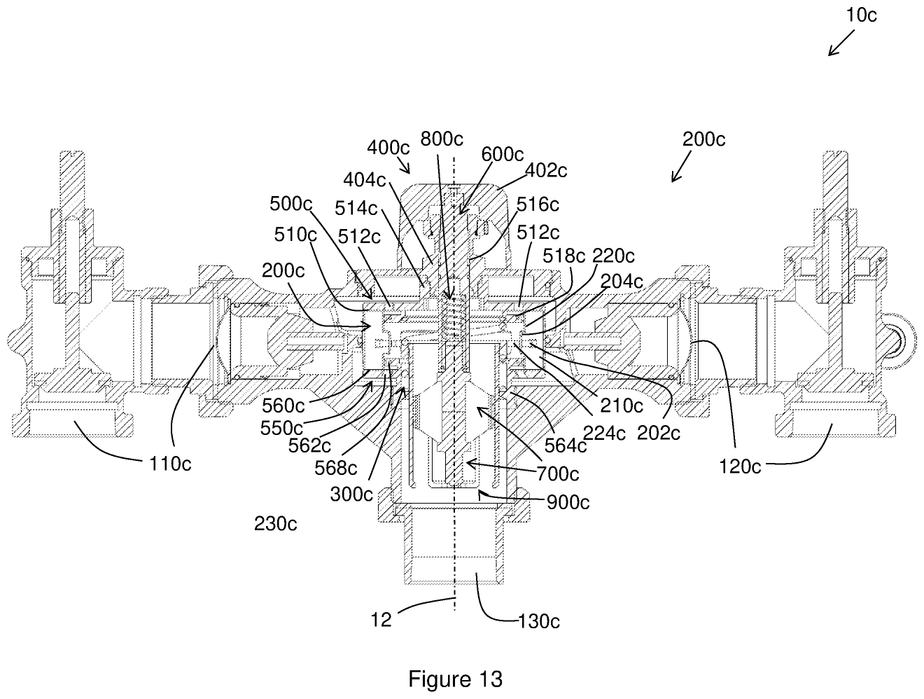

FIG. 13 illustrates a cross sectional view of a valve 10c, according to another embodiment of the invention. The valve 10c includes a housing 100c, a valve device in the form of piston 200c, a return spring 300c, a setting member 400c, a cold seat member 500c, a hot seat member 550c, an adjustment member 600c, thermostatic elements 700c, an overtravel spring 800a and an adjusting seat 900c.

The housing 100c includes a first inlet 110c, a second inlet 120c and an outlet 130c. An axial axis 12 extends along the housing 100c. As outlined further below, the housing 100a is configured to receive the components above (i.e. the piston 200c, return spring 300c etc.) therein and some components of the valve 10c are configured to move along or rotate around the axis 12.

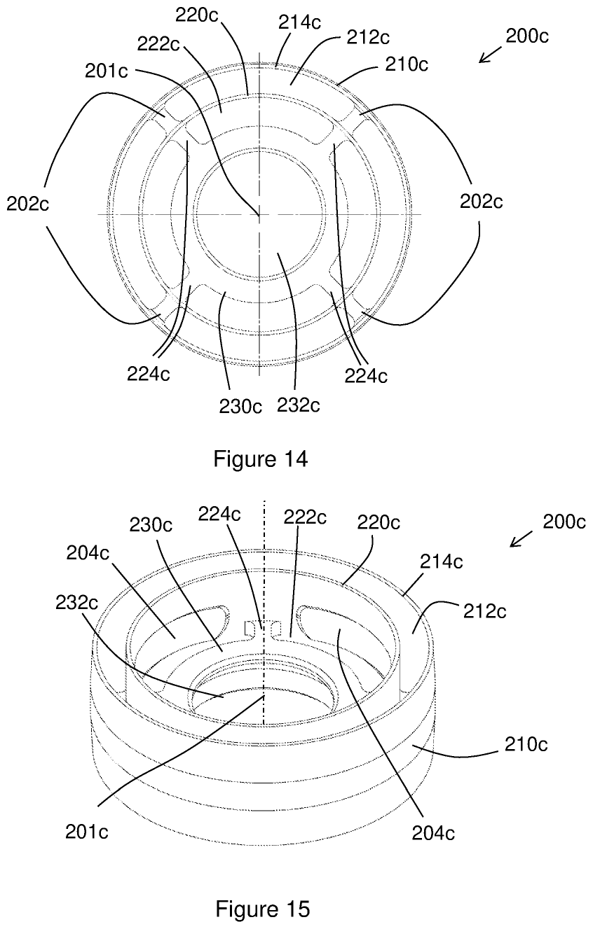

The piston 200c is illustrated in further detail in FIGS. 14 and 15. The piston 200c is formed from stainless steel in this embodiment and is positioned in the housing 100c adjacent a seal member. The seal member assists in separating fluid from the first inlet 110c and the second inlet 120c to opposite ends of the piston 200c. The piston 200c includes a first wall 210c that is connected to a second wall 220c by connecting members 202c. The first wall 210c and the second wall 220c are annular and define a central axis 201c therethrough. The end face of the first wall 210c and second wall 220c extend transversely to the central axis 202. As outlined further below, incoming fluid flow is directed around the ends of the first wall 210c and the second wall 220c to reduce the pressure drop of the valve 10c.

The second wall 220c is located in an inboard direction of the first wall 210c. That is, the second wall 220c is located closer to the central axis 201c extending therethrough in comparison to the first wall 210c. In this regard, the connecting member 202c separates the first wall 210c and the second wall 220c to form a first passage 212c through the piston 200c in a direction substantially parallel with the axis 201c (or axis 12).

To assist in moving fluid through the valve 10c, the second wall 220c of the piston 200c includes a plurality of apertures 204c. The apertures 204c extend from the outer circular face of the second wall 220c to the inner circular face of the second wall 220c. The plurality of apertures 204c are in the form of slots. The apertures 204c are symmetrically located on either side of the second wall 220c. In this regard, an even number of apertures 204c are normally included in the second wall 220c.

The second wall 220c is connected to an interior member 230c via connecting ribs 224c. As evident in FIG. 14, the connecting ribs 224 are substantially aligned with the connecting members 202c. A second passage 222c is located between the second wall 220c and the interior member 230c. The second passage 222c extends substantially parallel to the central axis 201c. In addition, the interior member 230c is substantially circular in this embodiment. The interior member 230c is also configured to receive part of the adjusting seat 900c, as further outlined below. Moreover, the interior member 230c is configured to receive a force from the return spring 300c in order to assist in biasing the piston 200c into a predetermined position.

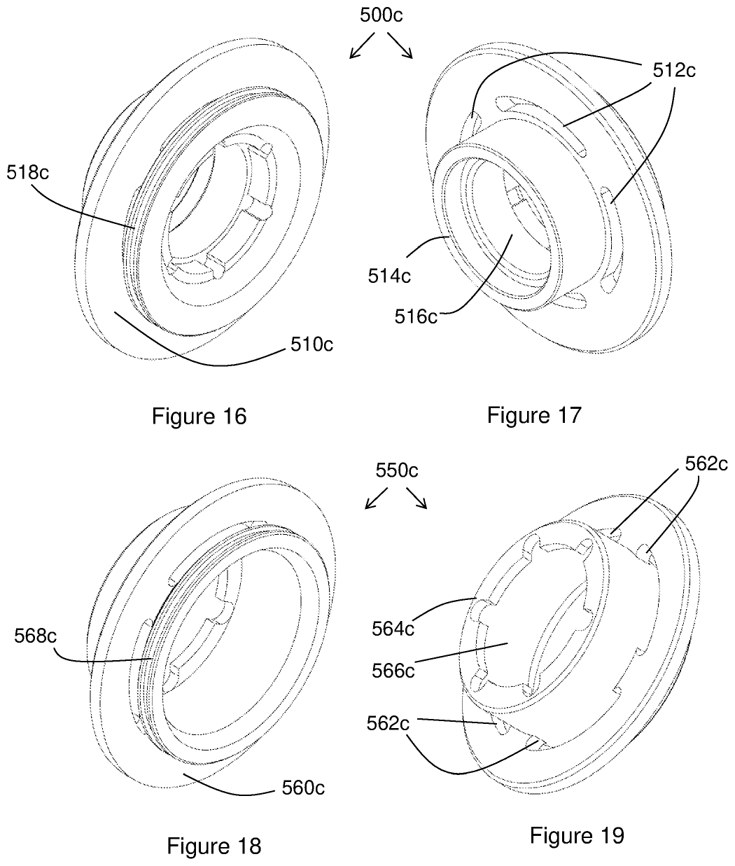

FIGS. 16 and 17 illustrate the cold seat member 500 in this embodiment. In this regard, it is noted that the hot and cold seat member terminology is used to distinguish one element from the other in this description and, as would be appreciated by a person skilled in the art, the function of the seat members 500c, 550c in assisting the regulation of hot and/or cold fluid may be interchanged. The cold seat member 500 is formed from stainless steel in this embodiment and includes a seating portion 510c. The seating portion 510c is substantially circular and planar in this embodiment. The seating portion 510c is configured to engage with an end of the piston 200c in order to assist in regulating (cold) fluid through the valve 10c.

Adjacent the seating portion 510c is a plurality of apertures 512c. The apertures 512c provide an opening that is located inboard of the second wall 220c of the piston 200c. A protrusion 514c is also located adjacent the apertures 512c and extends in one direction away from the seating portion 510c. The protrusion 514c defines an opening 516c that is configured to receive part of the cover 404c.

An extending member 518c extends from a position near the apertures 512c in a direction that is opposite to the protrusion 514c. The extending member 518c is somewhat in the form of an ‘L’ shape in this embodiment. Part of the extending member 518c is projected over the apertures 512c and provides a channel towards an end of the piston 200c. That is, part of the extending member 518c is directed towards the second wall 220c to channel fluid towards the first passage 212c. Furthermore, the extending member 518c assists in sealing an end of the second passage 222c of the piston 200c. Moreover, an end of the extending member 518c includes a sealing part that is configured to assist in providing a separate seal between the piston 200c and the cold seat member 500c. Typically, O-rings are retained by the sealing part to form a seal with the piston 200c.

As noted above, the hot seat member 550c is similar to the cold seat member 500c. The hot seat member 550c includes a sealing portion 560c and, in the same manner as the cold seat member 500c, the sealing portion 560c is configured to engage with an end of the piston 200c to assist with regulating (hot) fluid flow through the valve 10c. Moreover, the hot seat member 550c includes a protrusion 564c that is configured to receive part of the adjusting seat 900c. Apertures 562c are located adjacent to the protrusion 564c. The apertures 562c are located between the sealing portion 560c and the extending member 568c. The extending member 568c extends away from the sealing portion 560c in a manner that provides a projection over the apertures 562c, in order to channel fluid towards an end of the piston 200c. In a similar manner to the cold seat member 500c, the extending member 568c assists in providing a seal with the second wall 220c of the piston 200c with one or more O-rings. Furthermore, the extending member 568c assists sealing the second passage 222c of the piston 200c.

The adjustment member 600c of the valve 10c is configured to assist in setting a predetermined outlet fluid temperature. The adjustment member 600c is connected to an adjusting knob 402c and cover 404c of the setting member 400c. In response to rotating the adjusting knob 402c, the potential force exerted by the overtravel spring 800c on the thermostatic elements 700c is adjusted. This in turn adjusts the potential force exerted on the piston 200a as the adjusting seat 900c is configured to transfer forces from the thermostatic elements 700c through to the piston 200c. The forces on the piston 200c allow the piston 200c to move in order to regulate the flow of fluid from the outlet 130c at a predetermined temperature.

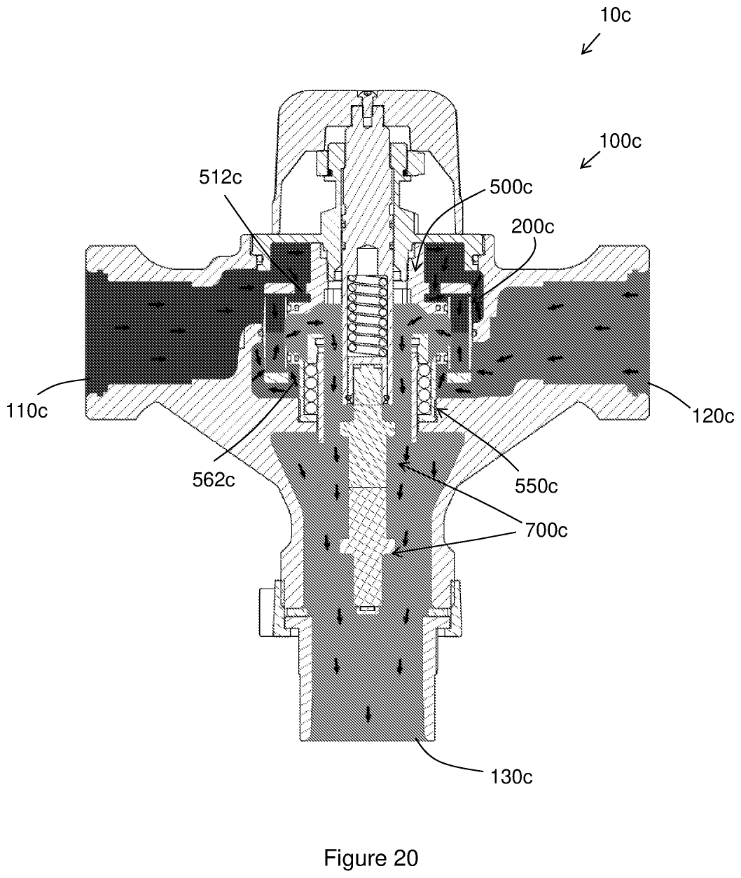

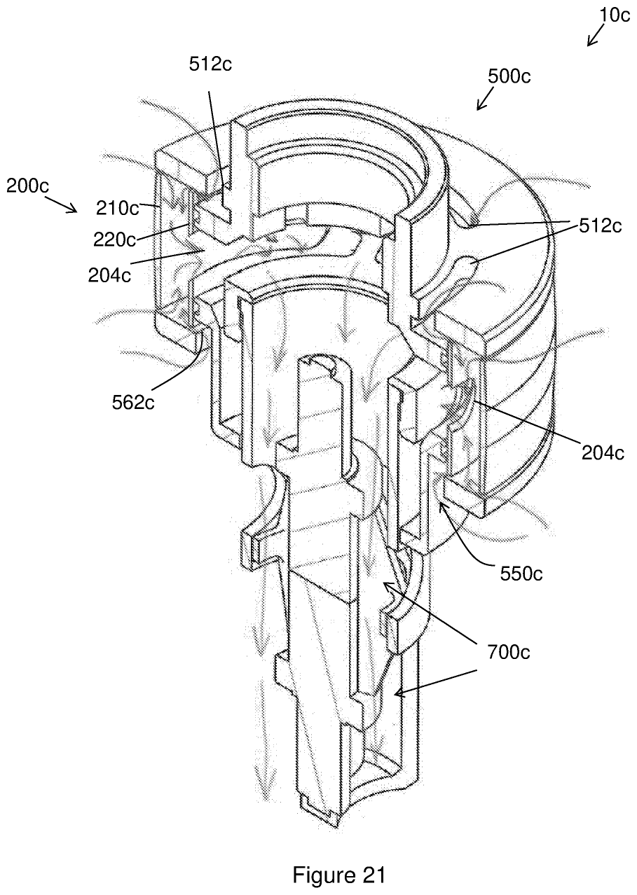

The potential flow of fluid through the valve 10c is illustrated in FIGS. 20 and 21. It is noted that components of the valve 10c in FIGS. 20 and 21 have been removed for ease of reference. FIGS. 20 and 21 illustrate the piston 200c settling in a position where it does not engage with either seat member 500c, 550c. In this position, relatively cold fluid moves through the first inlet 110c towards one end of the piston 200a. The cold fluid can then take: i) a path between the seating portion 510c and an end of the first wall 210c to the first passage 212c; or ii) a path along an opposite face to the seating portion 510c to the apertures 512c where the fluid is able to be channelled between the seating portion 510c and an end of the second wall 220c to the first passage 212c.

In a similar manner, the relatively hot fluid in FIGS. 20 and 21 moves through the second inlet 120c towards another end of the piston 200a. The hot fluid can then take: i) a path between the seating portion 560c and an opposite end of the first wall 210c to the first passage 212c; or ii) a path along an opposite face to the seating portion 560c to the apertures 562c where the fluid is able to be channelled between the seating portion 560c and an opposite end of the second wall 220c to the first passage 212c.

As evident in FIGS. 20 and 21, in the first passage 212c, the hot and cold fluid begins to mix and enters through the apertures 204c. Following this, the mixed fluid passes the second passage 222c and then exits the piston 200c via the third passage 232c. The mixed fluid then proceeds to flow over the thermostatic elements 700c to the outlet 130c. In response to the mixed fluid not being at a predetermined temperature, at least part of the thermostatic elements 700b are configured to move. This movement in turn shifts the adjusting seat 900c. This allows the piston 200c to be repositioned in order to substantially achieve the predetermined outlet temperature.

With the above in mind, the valves 10 provide, amongst other things, an increase in inlet area without affecting the distance required for the thermostatic elements 700 to adjust the flow through the first and second inlets 110, 120. This is achieved without the piston 200 or housing 100 increasing in size and results in a valve design with improved thermostatic performance and less flow restriction, without significant cost penalties.

To further elaborate, a key benefit of the valves 10 in the present invention is a piston 200 that, in addition to the traditional inlet area determined by the piston gap and diameter, has pathways to provide additional inlet area(s). These inlets increase the flow area coming into the valves 10 without affecting the distance required for the element 700 to open and close the inlets 110, 120.

Furthermore, the design of the valves 10 is such that the majority of the fluid flowing through the valve 10 is channelled through one or more of the passages 212, 222, 232 that are located perpendicular to the inlets 110, 120. Doing this results in fluid of a constant temperature surrounding the element 700 during operation, which may alleviate oscillation and other performance issues.

Moreover, the adjustment member 600 in the present invention i) moves the element 700 out of the centre of the piston 200, providing the room required for the concentric inlet 110, 120 design; and ii) provides a low profile setting member 400 which saves a significant amount of cost.

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above described invention.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

### PART ITEMS

| Embodiment #1 | Embodiment #2 | Embodiment #3 |
|---|---|---|
| Valve - 10a | Valve - 10b | Valve - 10c |
| Housing - 100a | Housing - 100b | Housing - 100c |
| First Inlet - 110a | | First Inlet - 110c |
| Second Inlet - 120a | | Second Inlet - 120c |
| Outlet - 130a | | Outlet - 130c |
| Piston - 200a | Piston - 200b | Piston - 200c |
| Pegs - 201 | Aperture - 204b | Central Axis - 201c |
| Connecting members - 202a | First Wall - 210b | Connecting members - 202c |
| Aperture - 204a | First Passage 212b | Aperture - 204c |
| First Wall - 210a | Second Wall - 220b | First Wall-210c |
| First Passage - 212a | Second Passage - 222b | First Passage 212c |
| Openings - 214a | Third Passage - 232b | Second Wall - 220c |
| Holes - 216a | | Second Passage - 222c |
| Second Wall - 220a | | Connecting Ribs - 224c |
| Second Passage - 222a | | Interior Member - 230c |
| Connecting Ribs - 224a | | Third Passage - 232c |
| Interior Member - 230a | | |
| Flow Separator - 240a | | |
| Separating Portion - 242a | | |
| Protrusions - 244a | | |
| Third Passage - 232a | | |
| Extension Portion - 250a | | |
| Return Spring - 300a | Return Spring - 300b | Return Spring - 300c |
| Setting member - 400a | Cap - 401b | Setting member - 400c |
| Connector - 410a | | Adjusting Knob - 402c |
| Clip - 420a | | Cover - 404c |
| Seat Member - 500a | Seat Member - 500b | Cold Seat Member - 500c |
| Seating Portion - 510a | | Seating Portion - 510c |
| Legs - 520a | | Apertures - 512c |
| | | Protrusion - 514c |
| | | Opening - 516c |
| | | Extending member - 518c |
| | | Hot Seat Member - 550c |
| | | Seating Portion - 560c |
| | | Apertures - 562c |
| | | Protrusion - 564c |
| | | Opening - 566c |
| | | Extending member - 568c |
| Adjustment Member - 600a | Adjustment Member - 600b | Adjustment Member - 600c |
| Protrusions - 610a | | |
| Fastening Portion - 620a | | |
| Thermostatic Element - 700a | Thermostatic Elements - 700b | Thermostatic Elements - 700c |
| Pin - 710a | | |
| Overtravel Spring - 800a | Overtravel Spring - 800b | Overtravel Spring - 800c |
| Seat - 900a | | Adjusting Seat - 900c |
| Outlet Fitting - 1000 | | |

1. A valve device for a valve, the valve device including:
a first wall configured to be received by a housing of the valve;
a second wall located in an inboard direction of the first wall, the first wall and the second wall defining a first passage configured to be in fluid communication with an outlet of the valve; and
a connecting member connecting the first wall to the second wall,
wherein at least the second wall has an aperture therethrough in the inboard direction and movement of the valve device in the housing is configured to adjust fluid flow from a first fluid inlet or a second fluid inlet, through the aperture, to the outlet.

2. The valve device of claim 1, wherein the second wall includes a plurality of apertures extending therethrough in the inboard direction.

3. The valve device of claim 1, wherein the first passage extends from one side of the valve device to another side of the valve device.

4. The valve device of claim 1, wherein at least part of the first wall and/or the second wall are annular.

5. The valve device of claim 1, wherein the first wall and/or the second wall are substantially circular.

6. The valve device of claim 1, wherein a central axis extends substantially parallel to the first wall and/or the second wall and transversely to the inboard direction.

7. The valve device of claim 1, wherein an interior member is connected to the second wall and configured to receive a force from a thermostatic element and/or spring.

8. A valve including:
a valve device of claim 1, the valve device being biased by a spring;
a housing having the first fluid inlet, the second fluid inlet and the outlet;
a thermostatic element configured to provide a force to the valve device to provide movement thereof to achieve a predetermined fluid temperature from the outlet.

9. The valve of claim 8, wherein the aperture is configured to be in fluid communication with the first fluid inlet whilst a further aperture extending through the second wall in the inboard direction is configured to be in fluid communication with the second fluid inlet.

10. The valve of claim 9, wherein movement of the valve device controls fluid flow from:
the first fluid inlet, through the aperture configured to be in fluid communication with the first fluid inlet, to the outlet; and
the second fluid inlet, through the further aperture configured to be in fluid communication with the second fluid inlet, to the outlet.

11. The valve of claim 8, wherein one or more seat members includes one or more apertures to provide a fluid path to the valve device.

12. The valve of claim 11, wherein the one or more seat members are separate components from the housing.

13. The valve of claim 11, wherein the one or more seat members include an extending member having a sealing portion that is configured to assist in sealing against the valve device.

14. The valve of claim 8, wherein in response to rotating at least part of a setting member, the distance between the thermostatic element and valve device is adjusted via turning an adjustment member.

15. A method of regulating temperature in a valve, the method including the steps of:
providing fluid to a first fluid inlet of the valve;
providing fluid to a second fluid inlet of the valve;
allowing the fluid from the first fluid inlet to flow past a first wall of a valve device and through a first aperture of a second wall of the valve device, the first aperture extending through the second wall in an inboard direction between the first wall and the second wall;
allowing the fluid from the second fluid inlet to flow past the first wall and through a second aperture of the second wall, the second aperture extending in the inboard direction; and
moving the valve device in order to adjust the fluid flow from the first fluid inlet and the second fluid inlet, past the valve device, to substantially achieve a predetermined fluid temperature from an outlet.

16. The method of claim 15, wherein the method further includes allowing the fluid from the first inlet and/or second inlet to proceed between the valve device and one or more seat members.

17. The method of claim 16, wherein the fluid moves past one or more apertures of the one or more seat members to a passage defined between the first wall and the second wall.

18. The method of claim 15, wherein the method further includes the step of rotating a setting member in order adjust the distance between a thermostatic element and the valve device.
